(19) United States
(12) Patent Application Publication
(10) Pub. No.: US 2008/0204384 A1
(43) Pub. Date: Aug. 28, 2008

(54) Organic electroluminescence display (OELD) and driving methods thereof

(76) Inventors: Jae-sung Lee, Suwon-si (KR); Chang-hoon Lee, Suwon-si (KR)

Correspondence Address: LEE & MORSE, P.C., 3141 FAIRVIEW PARK DRIVE, SUITE 500, FALLS CHURCH, VA, 22042, US

(21) Appl. No.: 12/071,438

(22) Filed: Feb. 21, 2008

(30) Foreign Application Priority Data
Feb. 23, 2007 (KR) 10-2007-0018700

(51) Int. Cl. G09G 3/32

(52) U.S. Cl. 345/83

(57) ABSTRACT

An OELD, including a pixel unit having a plurality of pixels to emit light, a photosensor configured to generate a control signal corresponding to an amount of ambient light, a control unit having a gamma control unit, a color coordinate control unit and a light emission control unit, the gamma control unit may be configured to set a gamma correction signal corresponding to the control signal, and the color coordinate control unit may be configured to correct a color coordinate of data signals corresponding to the control signal, a scan driver configured to generate scan signals to scan lines, a data driver configured to correct a gamma value of the data signals according to the data signals corrected in the color coordinate control unit and the gamma correction signal output from the gamma control unit, the data driver may be configured to supply the corrected gamma value to the data lines, and a power supply unit configured to supply power to the pixel unit.

### BACKGROUND OF THE INVENTION

1. Field of the Invention

Example embodiments relate to an organic electroluminescence display (“OELD”) and driving methods thereof and, more particularly, to an OELD having improved visibility and reduced power consumption by controlling luminance and/or saturation and driving methods thereof.

2. Description of the Related Art

Various flat panel display devices, i.e., plasma display panels (PDPs), liquid crystal displays (LCDs) and OELDs using organic light emitting diodes (OLEDs), are becoming widely used over other display devices, e.g., cathode ray tubes (CRTs), due to its small size, reduced weight and energy efficiency characteristics. In comparing the various flat panel display devices, however, the OELDs possess better luminous efficiency, luminance, viewing angle and response time.

The OELD are classified as a passive matrix type display device or an active matrix type display device depending on driving systems of pixels. The active matrix type display device, which may selectively turn on light in every unit pixel, has recently been widely used due to its resolution, contrast and/or response time characteristics. In addition, the display device may include a display region, in which a plurality of pixels may be arranged in a matrix to interface scan lines and data lines to each of the pixels and selectively apply a data signal to the pixels.

A conventional OELD, however, displays images with same grey levels by allowing the pixels to emit light regardless of brightness of ambient light. Accordingly, there is no difference in contrast of the displayed images. In addition, when the pixels emit light with a high luminance, there may be an increase in electric current flowing in the pixel unit due to a large number of pixels present, resulting in a high load for a power supply unit.

In addition, when OELD are employed in portable terminals, e.g., mobile phones, the portable terminals may be carried indoors and outdoors. However, during indoor use, it may be difficult for users to observe images on the display due to a faint ambient light. In addition, if a luminance of the OELD is increased to correspond to external light, there may be a shortened usage time because of the increased power consumption. Further, if the OELD emits light with the increased luminance in order to correspond to the brightness of the ambient light, visibility may become deteriorated due to a glaring effect.

### SUMMARY OF THE INVENTION

Example embodiments are therefore related to an OELD and driving methods thereof, which substantially overcome one or more of the problems due to the limitations and disadvantages of the related art.

It is therefore a feature of example embodiments to provide an OELD having improved visibility.

Another feature of example embodiments may provide an OELD having reduced power consumption by controlling luminance and/or saturation to correspond to ambient light.

At least one of the above and other features of example embodiments may be realized by providing an OELD, including a pixel unit having a plurality of pixels to emit light, the pixel unit including a plurality of data lines to supply data signals, a plurality of scan lines to supply scan signals and a plurality of light emission control signal lines to supply light emission control signals, a photosensor configured to generate a control signal corresponding to an amount of ambient light, a control unit having a gamma control unit, a color coordinate control unit and a light emission control unit, the gamma control unit may be configured to set a gamma correction signal corresponding to the control signal, and the color coordinate control unit may be configured to correct a color coordinate of the data signals corresponding to the control signal, a scan driver configured to generate the scan signals to the scan lines and control a pulse width of the light emission control signals output from the light emission control unit, a data driver configured to correct a gamma value of the data signals according to the data signals corrected in the color coordinate control unit and the gamma correction signal output from the gamma control unit, the data driver may be configured to supply the corrected gamma value to the data lines, and a power supply unit configured to supply power to the pixel unit.

The photosensor may include an analog/digital converter configured to convert an analog sensor signal corresponding to the ambient light into a digital sensor signal, a counter configured to count a number of signals during a one frame period so as to generate a counting signal, and a conversion processor configured to output a control signal corresponding to the digital sensor signal and the counting signal.

The gamma control unit may include a register unit formed of a plurality of registers to divide a brightness of the ambient light into a plurality of brightness levels and configured to store a gamma correction signal so that the plurality of the registers correspond to the plurality of the brightness levels, and a first selection unit configured to select one of the plurality of registers to correspond to the control signal set in the conversion processor and configured to output a gamma correction signal stored in the selected register. The gamma control unit may include a second selection unit for controlling an ON/OFF state of the gamma control unit. The gamma control unit may include a plurality of registers, and the data signal corrected by the operator unit may be gamma corrected by one of the plurality of registers.

The data driver further may include a gamma correction circuit unit for receiving the gamma correction signal to perform a gamma correction. The gamma correction circuit unit may include an amplitude control register configured to control an upper grey level voltage and a lower grey level voltage according to a register bit, a curve control register configured to control a gamma curve by selecting an intermediate grey level voltage using a register bit, a first selector configured to select the upper grey level voltage using the register bit set in the amplitude control register, a second selector configured to select the lower grey level voltage using the register bit set in the amplitude control register, a third to sixth selector configured to output the intermediate grey level voltage according to the register bit set in the curve control register, and a grey level voltage amplifier configured to output a plurality of grey level voltages corresponding to a plurality of grey levels to be displayed.

The color coordinate control unit may include a luminance look-up table configured to store luminance values, a saturation look-up table configured to store saturation values and an operator unit configured to correct the data signal by controlling color coordinates with the luminance values and the saturation values. The color coordinate control unit may generate the data signal using a previously set color coordinate if a brightness of the ambient light is less than a predetermined value. The color coordinate control unit may correct the data signal using the operator unit if a brightness of the ambient light is greater than a predetermined value.

At least one of the above and other features of example embodiments may be realized by providing a method for driving an OELD including controlling and correcting color coordinates of a data signal to correspond to a brightness of ambient light, and providing a gamma correction signal of the corrected data signal to a data driver.

The method may include supplying the corrected gamma signal to a plurality of data lines in a pixel unit. The method may further include converting an analog sensor signal corresponding to the brightness of ambient light into a digital sensor signal, counting a number of signals during a one frame period so as to generate a counting signal, and outputting a control signal corresponding to the digital sensor signal and the counting signal.

The method of correcting the gamma signal may include dividing the brightness of the ambient light into a plurality of brightness levels and storing the corrected gamma signal so that the plurality of the registers corresponds to the plurality of the brightness levels, and selecting one of the plurality of registers to correspond to a control signal and output the corrected gamma signal stored in the selected register.

The color coordinate may include a luminance value and a saturation value. The luminance value and the saturation value may determine a range to correspond to the ambient light. The data signal may be corrected by selecting a gamma correction value according to the brightness of the ambient light.

### BRIEF DESCRIPTION OF THE DRAWINGS

The above and other features and advantages of example embodiments will become more apparent to those of ordinary skill in the art by describing in detail example embodiments thereof with reference to the attached drawings, in which:

FIG. 1 illustrates a schematic diagram of an OELD according to an example embodiment;

FIG. 2 illustrates a schematic diagram of an exemplary photosensor used in the OELD according to an example embodiment;

FIG. 3 illustrates a schematic diagram of an exemplary A/D converter of the photosensor of FIG. 2;

FIG. 4 illustrates a schematic diagram of an exemplary gamma control unit of the OELD of FIG. 1;

FIG. 5 illustrates a schematic diagram of an exemplary gamma correction circuit unit of the OELD of FIG. 1;

FIG. 6 illustrates a schematic diagram of an exemplary light emitting control unit of the OELD of FIG. 1;

FIG. 7 illustrates a schematic diagram of an exemplary color coordinate control unit of the OELD of FIG. 1;

FIG. 8 illustrates a flow chart for operating the color coordinate control unit illustrated in FIG. 7; and

FIG. 9 illustrates a circuit diagram of an exemplary pixel used in the OELD of FIG. 1.

### DETAILED DESCRIPTION OF THE INVENTION

Korean Patent Application No. 10-2007-0018700, filed on Feb. 23, 2005, in the Korean Intellectual Property Office, and entitled: “Organic Electro Luminescence Display and Driving Method Thereof,” is incorporated by reference herein in its entirety.

Example embodiments will now be described more fully hereinafter with reference to the accompanying drawings; however, the example embodiments may be embodied in different forms and should not be construed as limited to the embodiments set forth herein. Rather, these example embodiments are provided so that this disclosure will be thorough and complete, and will fully convey the scope of the invention to those skilled in the art.

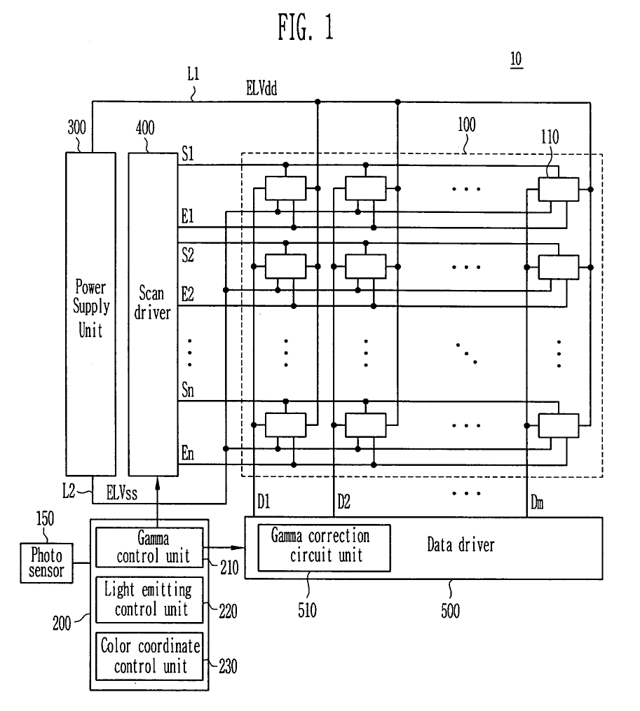

Referring to FIG. 1, an OELD 10 may include a pixel unit 100, a photosensor 150, a control unit 200, a power supply unit 300, a scan driver 400, and a data driver 500. Other devices may be included or excluded in the org OELD 10 besides the ones mentioned above.

The pixel unit 100 may have a plurality of pixels 110 arranged therein, and an OLED (not shown) may be connected to each of the pixels 110. The pixel unit 100 include n number of scan lines (S1, S2, . . . Sn−1, Sn) formed in a longitudinal direction for supplying a scan signal, n number of light emission control signal lines (E1, E2, . . . En−1, En) for supplying a light emission control signal, m number of data lines (D1, D2, . . . Dm−1, Dm) formed in a vertical direction for supplying a data signal, a first power source line (L1) for supplying a first power source (EL Vdd) to the pixels 110, and a second power source line (L2) for supplying a second power source (EL Vss) to the pixels 110. In addition, the second power source line (L2) may be electrically connected to each of the pixels 110 due to the second power source line (L2) being formed over a region of the pixel unit 100.

The photosensor 150 may sense ambient light and may output a control signal corresponding to a brightness of the sensed ambient light. The control signal generated by the photosensor 150 may then be supplied to the control unit 200.

The control unit 200 may be composed of a gamma control unit 210, a light emission control unit 220, and a color coordinate control unit 230. The gamma control unit 210 may receive the control signal from the photosensor 150, and may generate a gamma correction signal according to the received control signal. Accordingly, the gamma control unit 210 may generate a gamma correction signal corresponding to the ambient light and may supply the generated gamma correction signal to the gamma correction circuit. The light emission control unit 220 may set a maximum value of an electric current flowing in one frame. In addition, a capacity of the electric current flowing in one frame may not exceed the maximum value since the sum of the data signal is estimated. The color coordinate control unit 230 may further change color coordinates to correspond to the ambient light, and may generate a data signal having the changed color coordinates. For example, if data for red color is input, then the color coordinate control unit 230 may change the color coordinates to correspond to the ambient light to display a red color with an orange or scarlet color.

The power supply unit 300 may supply the first power source (EL Vdd) and the second power source (EL Vss) to the pixel unit 100. The power supply unit 300 may allow the electric current, which may correspond to the data signal, to flow in each of the pixels 110 by means of a difference between the first power source (EL Vdd) and the second power source (EL Vss).

The scan driver 400 may supply the scan signal and the light emission control signal to the pixel unit 100. The scan driver 400 may be further connected to the scan lines (S1, S2, . . . Sn−1, Sn) and the light emission signal lines (E1, E2, . . . En−1, En) to supply the respective scan and light emission control signals to a certain row of the pixel unit 100. The data signal output from the data driver 500 may be supplied to the pixels 110 to which the scan signal may be supplied. The pixels 110 may further be allowed to emit the light color corresponding to the light emission control signal.

The scan driver 400 may be divided into a scan drive circuit (not shown) for generating a scan signal and a light emission drive circuit (not shown) for generating a light emission control signal. The scan drive circuit and the light emission drive circuit may be formed integrally or as separate components.

The data signal input from the data driver 500 may be applied to a specific row of the pixel unit 100 to which the scan signal is supplied. Further, the electric current corresponding to the light emission control signal and the data signal may be supplied to the OLED to display an image using the light emitted from the OLED. Accordingly, there may be one complete frame when all of the rows are sequentially selected.

The data driver 500 may supply the data signal to the pixel unit 100 and may receive a video data having red, blue and green components to generate the data signal. The data driver 500 may be connected to the data lines (D1, D2, . . . Dm−1, Dm) of the pixel unit 100 to supply the generated data signal to the pixel unit 100. Further, the data driver 500 may include a gamma correction circuit unit 510. The gamma correction circuit unit 510 may control a ratio of luminance to grey levels to improve visibility. In particular, the gamma correction circuit unit 510 may control the ratio of the luminance to the grey levels by receiving a data signal output from the control unit 200 to control grey level voltages (VHI to VLO). The gamma correction circuit unit 510 may improve the visibility by controlling the grey level voltages (VHI to VLO), e.g., increasing the grey level voltage if the ambient light is strong and decreasing the grey level voltage if the ambient light is weak.

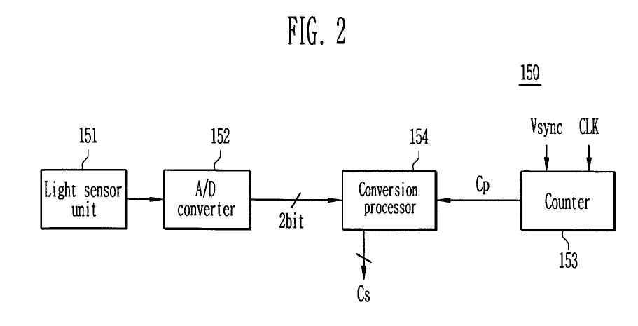

Referring to FIG. 2, the photosensor 150 may include a light sensor unit 151, an A/D converter 152, a counter 153 and a conversion processor 154. The light sensor unit 151 may measure a brightness of ambient light and may divide the brightness of ambient light into a plurality of brightness levels to output an analog sensor signal corresponding to each of the brightness levels.

The A/D converter 152 may compare the analog sensor signal output from the light sensor unit 151 with a predetermined reference voltage and may output a digital sensor signal corresponding to a reference voltage. For example, the A/D converter 152 may output a sensor signal having a value ‘11’ in the brightest brightness level of ambient light and may output a sensor signal having a value ‘10’ in other brightness level of ambient light. Alternatively, the A/D converter 152 may output a sensor signal having a value ‘01’ in the dark brightness level of ambient light and may output a sensor signal having a value ‘00’ in the darkest brightness level of ambient light.

The counter 153 may count a number of sensor signals during a specific period via a vertical synchronizing signal (Vsync) supplied from the outside, and may output a counting signal (Cp) corresponding to the number of sensor signals. For example, if the counter 153 uses a binary numeral value of 2 bits, the counter 153 may reset a sensor signal having a value ‘00’ when the vertical synchronizing signal (Vsync) is input. The counter 153 may then count the number of sensor signals having a value ‘11’ by sequentially shifting a clock (CLK) signal. Further, if the vertical synchronizing signal (Vsync) is input to the counter 153 more than one time, the counter 153 may be re-set to a reset state. The counter 153 may sequentially count the number of sensor signals from ‘00’ to ‘11’ during a one frame period. The counter 153 may then output a counting signal (Cp), which may correspond to the counted number of sensor signals, to the conversion processor 154.

The conversion processor 154 may use the counting signal (Cp) output from the counter 153 and the sensor signal output from the A/D converter 152 to output a control signal (Cs), in which the control signal (Cs) may be used to select a set value of each register. In other words, the conversion processor 154 may output the control signal (Cs) corresponding to the selected sensor signal output from the A/D converter 152, and may maintain the control signal (Cs) output during a one frame period by the counter 153. Further, during a selection of a next frame period, the conversion processor 154 may reset the output control signal (Cs), which may also correspond to the sensor signal output from the A/D converter 152. According, the conversion processor 154 may continue to maintain the control signal (Cs) during each frame period. For example, the conversion processor 154 may output the control signal (Cs) corresponding to a sensor signal of ‘11’ and may maintain the control signal (Cs) during a one frame period when the counter 153 counts the number of sensor signals according to ambient light in the brightest state. In addition, the conversion processor 154 may output the control signal (Cs) corresponding to a sensor signal of ‘00’ and may maintain the control signal (Cs) during a one frame period when the counter 153 counts the number of sensor signals according to ambient light in the darkest state. Further, in other bright and dark brightness levels of ambient light, the conversion processor 154 may output the control signals (Cs) corresponding to sensor signals between ‘10’ and ‘01’ and may maintain the control signal, respectively, in the same manner as described above.

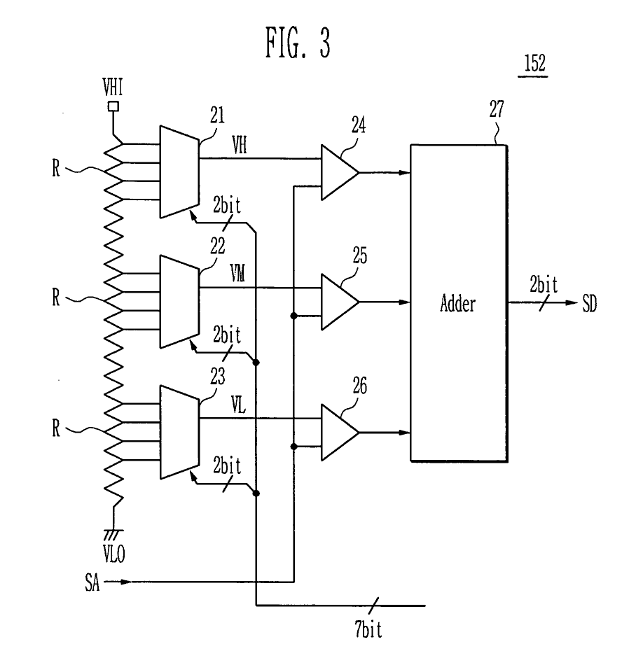

Referring to FIG. 3, the A/D converter 152 may include first to third selectors 21, 22, 23, first to third comparators 24, 25, 26 and an adder 27. The first to third selectors 21, 22, 23 may receive voltages distributed through a plurality of resistor arrays R for generating a plurality of grey level voltages (VH1 to VLO). The first to third selectors 21, 22, 23 may further compute the grey level voltages (VHI to VLO) with a set value for each selector, e.g., a binary numeral value of 2 bits. The first to third selectors 21, 22, 23 may then assign the grey level voltages (VHI to VLO) to the respective comparators 24, 25, 26.

The first comparator 24 may compare the first reference voltage (VH) with an analog sensor signal (SA) and may output the comparison results. For example, the first comparator 24 may output a sensor signal of ‘1’ if the analog sensor signal (SA) is greater than the first reference voltage (VH), and may output a sensor signal of ‘0’ if the analog sensor signal (SA) is lower than the first reference voltage (VH). The second comparator 25 may compare the second reference voltage (VM) with the analog sensor signal (SA) and may then output the comparison results. The third comparator 26 may compare the third reference voltage (VL) with the analog sensor signal (SA) and may then output the comparison results. Further, the analog sensor signal (SA) corresponding to a digital sensor signal (SD) may be changed by varying the first to third reference voltages (VH to VL).

The adder 27 may add all of the resulting values output from the first to third comparators 24, 25, 26. The added values may then be output by the adder 27 as a digital sensor signal (SD), e.g., a 2-bit digital sensor signal.

In an implementation, the A/D converter 152 may set the first reference voltage (VH) to 1V, the second reference voltage (VM) to 2V and the third reference voltage (VL) to 3V. The A/D converter 152 may further increase a voltage value of the analog sensor signal (SA) when the ambient light becomes brighter. If the analog sensor signal (SA) is lower than 1V, the first to third comparators 24, 25 and 26 may output sensor signals of ‘0’, ‘0’ and ‘0’, respectively, so that the adder 27 may output a digital sensor signal (SD) of ‘00’. If the analog sensor signal (SA) is set between 1V and 2V, the first to third comparators 24, 25 and 26 may output sensor signals of ‘1’, ‘0’ and ‘0’, respectively, so that the adder 27 may output a digital sensor signal (SD) of ‘01’. If the analog sensor signal (SA) is set between 2V and 3V, the adder 27 may output a digital sensor signal (SD) of ‘10’. If the analog sensor signal (SA) is greater than 3V, the adder 27 may output a digital sensor signal (SD) of ‘11’. In the present example embodiment, the A/D converter 152 may divide the ambient light into four brightness levels, e.g., a sensor signal of ‘00’ in a darkest brightness level, a sensor signal of ‘01’ in a dark brightness level, a sensor signal of ‘10’ in a bright brightness level and a sensor signal of ‘11’ in a brightest brightness level.

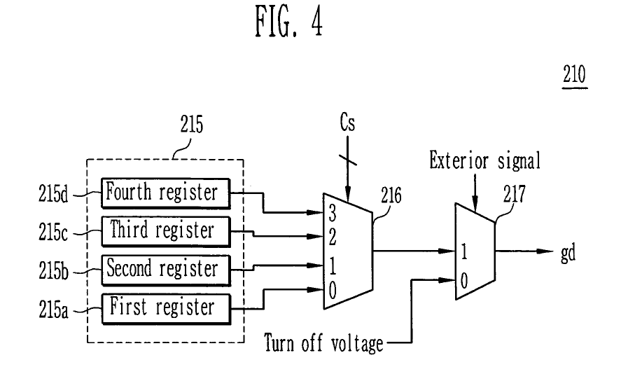

Referring to FIG. 4, the gamma control unit 210 may include a register unit 215, a first selection unit 216 and a second selection unit 217. The gamma control unit 210 may serve to receive the control signal (Cs) output from the photosensor 150 and may output a gamma correction signal (gd) corresponding to the gamma correction data in the gamma control unit 210.

The register unit 215 may divide the ambient light into a plurality of brightness levels and may store a gamma correction data corresponding to the gamma correction signal (gd) used in each of the brightness levels. The register unit 215 may be composed of four registers, e.g., first to fourth registers 215a, 215b, 215c, 215d. There may be more or less register units 215 employed in the gamma control unit 210.

In an implementation, the first register 215a may store a gamma correction data corresponding to the gamma correction signal (gd) if the ambient light is in the darkest brightness level, the second register 215b may store a gamma correction data corresponding to the gamma correction signal (gd) if the ambient light is in the dark brightness level, the third register 215c may store a gamma correction data corresponding to the gamma correction signal (gd) if the ambient light is in the bright brightness level, and the fourth register 215d may store a gamma correction data corresponding to the gamma correction signal (gd) if the ambient light is in the brightest brightness level.

The second selection unit 217 may receive an exterior signal, e.g., a 1-bit set value, for controlling an ON/OFF state. For example, the gamma control unit 210 may be turned on if an exterior signal of ‘1’ is selected, and the gamma control unit 210 may be turned off if an exterior signal of ‘0’ is selected. As a result, the second selection unit 217 may selectively control the brightness according to the ambient light.

Referring to FIG. 5, the gamma correction circuit unit 510 may include a ladder resistor 61, an amplitude control register 62, a curve control register 63, a plurality of selectors, e.g., a first selector 64 to a sixth selector 69, and a grey level voltage amplifier 70. The ladder resistor 61 may set an uppermost grey level voltage (VHI) and a lowermost grey level voltage (VLO), supplied from the outside, as reference voltages. The ladder resistor 61 may further include a plurality of variable registers between the uppermost grey level voltage (VHI) and the lowermost grey level voltage (VLO) connected in series. Precision in controlling the grey level voltages (VHI) may be improved when the ladder resistor 61 registers a low value because there is a narrow range of controlling or differentiating an amplitude of the control signal. Alternatively, precision in controlling the grey level voltages (VHI) may be reduced when the ladder resistor 61 registers a high value because there is a wide range of controlling or differentiating an amplitude of the control signal.

The amplitude control register 62 may output a 3-bit register value to the first selector 64 and may output a 7-bit register value to the second selector 65. The amplitude control register 62 may selectably increase grey level voltages (VHI to VLO) by increasing a set bit number. The grey level voltages (VHI to VLO) may further be selected by changing a register value.

The curve control register 63 may respectively output a 4-bit register value to the third selector 66 through the sixth selector 69. The register value may be changed and the selectable grey level voltage (VHI to VLO) may be controlled according to the register value. Further, the register value, i.e., an upper 10 bits, may be input to the amplitude control register 62, and the register value, i.e., a lower 10 bits, may be input to the curve control register 63. The register values may be generated in the register generation unit 215.

The first selector 64 may select a grey level voltage, corresponding to the 3-bit register value set in the amplitude control register 62, from the plurality of grey level voltages (VH1 to VHO) distributed through the ladder resistor 61. The first selector 64 may output the selected grey level voltage as the uppermost grey level voltage (VHI).

The second selector 65 may select a grey level voltage, corresponding to the 7-bit register value set in the amplitude control register 62, from the plurality of grey level voltages (VHI to VLO) distributed through the ladder resistor 61. The second selector 65 may output the selected grey level voltage as the lowermost grey level voltage (VLO).

The third selector 66 may distribute a voltage between grey level voltages output from the first selector 64 and the second selector 65 through a plurality of resistor arrays. The third selector 66 may further select and output a grey level voltage corresponding to a 4-bit register value set in the curve control register 63.

The fourth selector 67 may distribute a voltage between grey level voltages output from the first selector 64 and the third selector 66 through a plurality of resistor arrays. The fourth selector 67 may further select and output a grey level voltage corresponding to the 4-bit register value set in the curve control register 63.

The fifth selector 68 may distribute a voltage between grey level voltages output from the first selector 64 and the fourth selector 67 through a plurality of resistor arrays. The fifth selector 68 may further select and output a grey level voltage corresponding to the 4-bit register value set in the curve control register 63.

The sixth selector 69 may distribute a voltage between grey level voltages output from the first selector 64 and the fifth selector 68 through a plurality of resistor arrays. The sixth selector 69 may further select and output a grey level voltage corresponding to the 4-bit register value set in the curve control register 63.

The grey level voltage amplifier 70 may output the plurality of reference voltages (e.g., V0, V3, V7, V15, V31 and V63) corresponding to each grey level. The plurality of reference voltages (e.g., V0, V3, V7, V15, V31 and V63) may then be displayed in the pixel unit 100.

Accordingly, because intermediate grey levels may be controlled according to the register set values of the curve control register 63, gamma value characteristics may be easily controlled. Further, the resistance values of each ladder resistor 61 may be set so that an electric potential difference between the grey levels may be higher and displayed with a low grey level and advance the gamma value characteristics downwards. Alternatively, the resistance value of each ladder resistor 61 may be set so that the electric potential difference between the grey levels may be smaller and displayed with a low grey level and advance the gamma value characteristics upwards.

Further, the amplitude and the curve may be set in R, G and B groups by the amplitude control register 62 and the curve control register 63 by positioning a gamma correction circuit in the R, G and B groups. Thus, a substantially identical luminance characteristic may be obtained according to changes in the characteristics of the R, G and B groups.

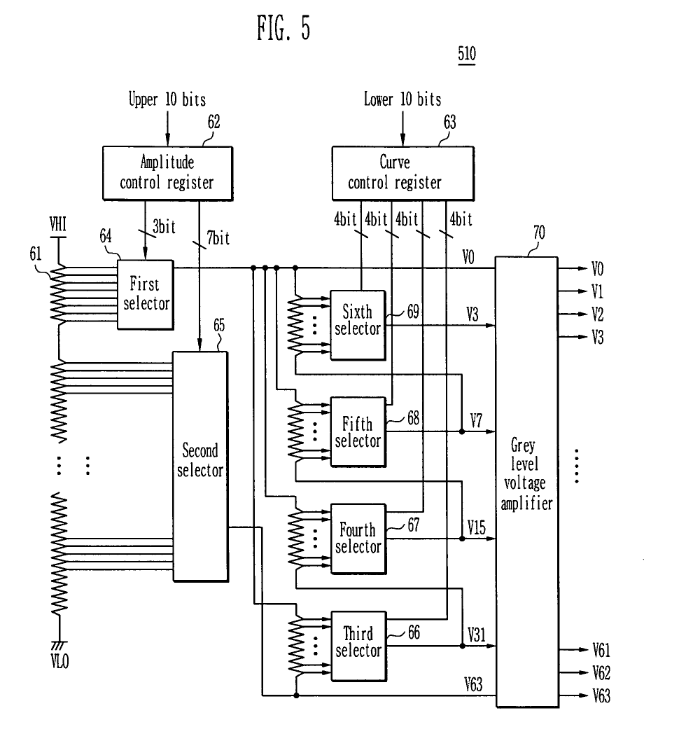

Referring to FIG. 6, the light emission control unit 220 may serve to control the brightness of the pixel unit 100 according to a light emission rate. The light emission control unit 220 may include a data sum-up unit 221, a look-up table 222 and a luminance control driver 223.

The data sum-up unit 221 may estimate a size of a frame data, which may be a value obtained by summing up a video data input to each of the pixels 110 emitting light during a one frame period. In other words, the value, obtained by summing up a video data input to each of the pixels 110 emitting light during a one frame period, may be referred to as a frame data. The size of the frame data may correspond to the pixel unit 100 having a high light emission rate or, alternatively, a presence of a large number of pixels 110 of a given display image having a high grey level. Further, if the size of the frame data is greater than a predetermined value, the size of the frame data may correspond to a high electric current capacity flowing in the entire pixel unit 100, so that a brightness of the entire pixel unit 100 may be controlled, e.g., reduce the brightness of the entire pixel unit 100. Accordingly, when the brightness of the entire pixel unit 100 is reduced, light-emitting pixel units 100 may have a high luminance and may maintain a high luminance difference (or a high contrast ratio) between the light-emitting pixel units and non-light-emitting pixel units. Alternatively, when the brightness of the entire pixel unit 100 is not reduced, the luminance of the light-emitting pixel units may be increased by maintaining a light emission time of the light-emitting pixel units for a sufficient amount of time, e.g., increase contrast ratios of the light-emitting pixel units and the non-light-emitting pixel units. As such, the image may be clearly displayed when the contrast ratios of the light-emitting pixel units and the non-light-emitting pixel units are increased.

The look-up table 222 may store information on a ratio between a light emission period and a non-light emission period of the light emission control signal, which may correspond to an upper 5-bit value of the frame data. The information stored in the look-up table 222 may be used to estimate the brightness of the pixel unit 100 emitting light during a one frame period.

The luminance control driver 223 may output a luminance control signal. The luminance control signal may control the ratio between the light emission period and the non-light emission period of the light emission control signal input to the pixel unit 100 when the size of the frame data of the pixel unit 100 is higher than a predetermined size. Further, if the luminance control ratio continues to be increased in proportion to the increased luminance of the pixel unit 100, a bright screen may not be provided due to an excessive luminance control, resulting in a reduction of brightness of the entire pixel unit 100. Accordingly, the entire brightness of the pixel unit 100 may be controlled by setting the maximum control range of the luminance.

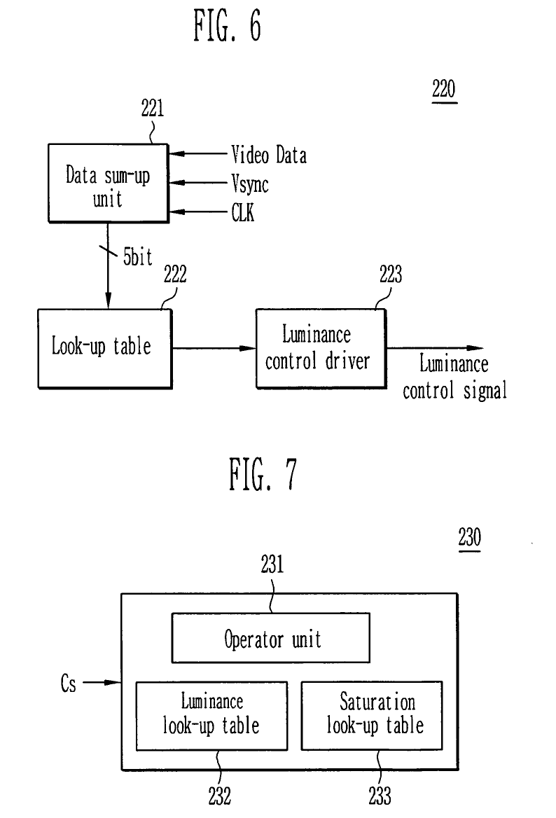

Referring to FIG. 7, the color coordinate control unit 230 may include an operator unit 231, a luminance look-up table 232 and a saturation look-up table 233. The color coordinate control unit 230 may receive a control signal (Cs) from the photosensor 150 and may operate to correspond to the ambient light. Further, the color coordinate control unit 230 may be operated when an intensity of the ambient light is set to the brightest brightness level, and may correct a data signal by correcting the color coordinates. Further, a gamma value corrected in the gamma control unit may be set to the fourth register 215d (shown in FIG. 4).

The operator unit 231 may change the color coordinates of the data signal using a range of color coordinates estimated by the luminance look-up table 232 and the saturation look-up table 233 corresponding to the intensity of the ambient light. The operator unit 231 may generate a data signal corresponding to the changed color coordinates. The operator unit 231 may change the color coordinates according to a predetermined algorithm.

The luminance look-up table 232 may be a look-up table containing luminance information and the saturation look-up table 233 may be a look-up table containing color information. The luminance look-up table 232 and the saturation look-up table 233 may be calculated on the basis of the results observed by tested subjects, e.g., the subjects may estimate the easiest visual state by changing the color coordinates while viewing an image. Further, the luminance look-up table 232 and the saturation look-up table 233 may be used to estimate a correction value of the data signal.

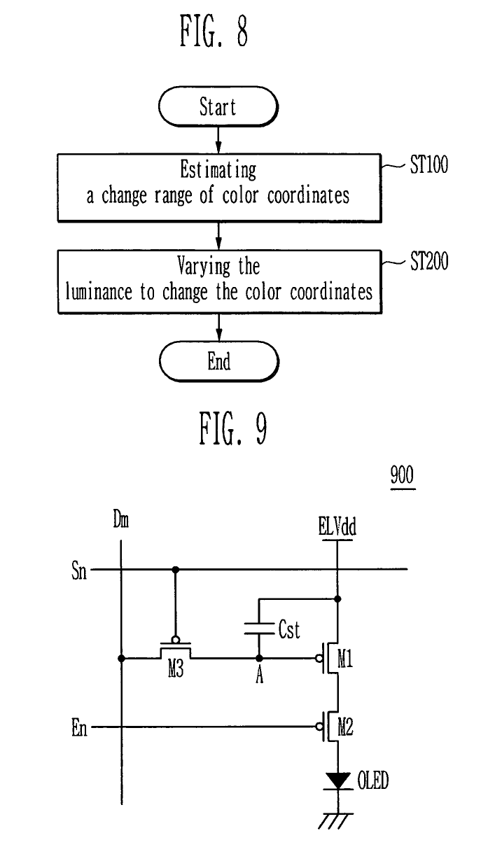

FIG. 8 illustrates a flow chart of an algorithm used for operating the color coordinate control unit 230. The algorithm may be used in changing R, G and B color coordinates to correspond to an input R, G and B data and ambient light.

In ST100, a range of color coordinates to be changed so as to correspond to the input R, G and B data and ambient light may be estimated. The color coordinates may include coordinates for luminance and saturation so as to estimate any changed range of luminance and saturation according to intensity of the ambient light. In other words, due to the changes in the luminance and saturation, observers may estimate the range in which to recognize a red color as red even if the red color is changed into other colors.

In ST200, the luminance and saturation may be varied to change the color coordinates using a previously set luminance look-up table and saturation look-up table. For example, the luminance value and the saturation value of the R, G and B data may vary because the R, G and B data may be changed according to the change in the color coordinates. The gamma correction may be performed to control the grey level voltage without changing the data signal. Further, the data signal may be changed in the algorithm.

FIG. 9 illustrates a diagram of a circuit 900 of a pixel 110 used in the OELD of FIG. 1. The pixel 110 may include the OLED and the circuit 900. The circuit 900 may include a first transistor (M1), a second transistor (M2), a third transistor (M3) and a storage capacitor (Cst). Each of the first transistor (M1), the second transistor (M2) and the third transistor (M3) may have a gate, a source and a drain. The storage capacitor (Cst) may include a first electrode and a second electrode.

The first transistor (M1) may have the source connected with the first power source (EL Vdd), the drain connected with the source of the second transistor (M2), and the gate connected with the first node (A). The first node (A) may be connected to the drain of the third transistor (M3). The first transistor (M1) may supply the electric current corresponding to the data signal to the OLED.

The second transistor (M2) may have the source connected with the drain of the first transistor (M1). The drain of the first transistor (M1) may be connected with an anode electrode of the OLED, and the gate may be connected with the light emission control line (En). The second transistor (M2) may respond to the light emission control signal. Thus, the light emission of the OLED may be controlled by controlling a flow of an electric current flowing from the first transistor (M1) toward the OLED according to the light emission control signal.

The third transistor (M3) may have the source connected with the data line (Dm), the drain connected with the first node (A) and the gate connected with the scan line (Sn). The third transistor (M3) may further supply the data signal to the first node (A) according to the scan signal applied to the gate.

The storage capacitor (Cst) may have the first electrode connected with the first power source (EL Vdd) and the second electrode connected with the first node (A). The storage capacitor (Cst) may charge an electric charge according to the data signal and may apply a signal to the gate of the first transistor (M1) during a one frame period. The storage capacitor (Cst) may further use the charged electric charge so as to sustain an operation of the first transistor (M1) during a one frame period.

Example embodiments relate to an OELD having reduced power consumption and lower manufacturing cost by decreasing a size of a power supply unit. The OELD may further improve visibility by enhancing contrast ratios of the pixel units. Accordingly, the display may allow a viewer to recognize images more readily under bright ambient light conditions.

Example embodiments of the present invention have been disclosed herein, and although specific terms are employed, they are used and are to be interpreted in a generic and descriptive sense only and not for purpose of limitation. Accordingly, it will be understood by those of ordinary skill in the art that various changes in form and details may be made without departing from the spirit and scope of the present invention as set forth in the following claims.

What is claimed is:

1. An organic electroluminescence display (OELD), comprising:
a pixel unit having a plurality of pixels to emit light, the pixel unit including a plurality of data lines to supply data signals, a plurality of scan lines to supply scan signals and a plurality of light emission control signal lines to supply light emission control signals;
a photosensor configured to generate a control signal corresponding to an amount of ambient light;
a control unit having a gamma control unit, a color coordinate control unit and a light emission control unit, the gamma control unit is configured to set a gamma correction signal corresponding to the control signal, and the color coordinate control unit is configured to correct a color coordinate of the data signals corresponding to the control signal;
a scan driver configured to generate the scan signals to the scan lines and control a pulse width of the light emission control signals output from the light emission control unit;
a data driver configured to correct a gamma value of the data signals according to the data signals corrected in the color coordinate control unit and the gamma correction signal output from the gamma control unit, the data driver is configured to supply the corrected gamma value to the data lines; and
a power supply unit configured to supply power to the pixel unit.

2. The OELD as claimed in claim 1, wherein the photosensor further comprises:
an analog/digital converter configured to convert an analog sensor signal corresponding to the amount of ambient light into a digital sensor signal;
a counter configured to count a number of signals during a one frame period so as to generate a counting signal; and
a conversion processor configured to output the control signal in accordance to the digital sensor signal and the counting signal.

3. The OELD as claimed in claim 1, wherein the gamma control unit further comprises:
a register unit having a plurality of registers to divide a brightness of the ambient light into a plurality of brightness levels and store the gamma correction signal so that the plurality of the registers correspond to the plurality of the brightness levels; and
a first selection unit configured to select one of the plurality of registers to correspond to the control signal set in the conversion processor and output the gamma correction signal stored in the selected register.

4. The OELD as claimed in claim 3, wherein the gamma control unit further comprises a second selection unit configured to control an ON/OFF state of the gamma control unit.

5. The OELD as claimed in claim 1, wherein the data driver further comprises a gamma correction circuit unit configured to receive the gamma correction signal to perform a gamma correction.

6. The OELD as claimed in claim 5, wherein the gamma correction circuit unit further comprises:
an amplitude control register configured to control an upper grey level voltage and a lower grey level voltage according to a register bit;
a curve control register configured to control a gamma curve by selecting an intermediate grey level voltage using the register bit;
a first selector configured to select the upper grey level voltage according to the register bit set in the amplitude control register;
a second selector configured to select the lower grey level voltage according to the register bit set in the amplitude control register;
a third to sixth selector configured to output the intermediate grey level voltage according to the register bit set in the curve control register; and
a grey level voltage amplifier configured to output a plurality of grey level voltages corresponding to a plurality of grey levels to be displayed.

7. The OELD as claimed in claim 1, wherein the color coordinate control unit comprises a luminance look-up table configured to store luminance values, a saturation look-up table configured to store saturation values and an operator unit configured to correct the data signal by controlling color coordinates in accordance to the luminance values and the saturation values.

8. The OELD as claimed in claim 7, wherein the color coordinate control unit generates the data signal using a previously set color coordinate if a brightness of the ambient light is less than a predetermined value.

9. The OELD as claimed in claim 7, wherein the color coordinate control unit corrects the data signal using the operator unit if a brightness of the ambient light is greater than a predetermined value.

10. The OELD as claimed in claim 7, wherein the data signal corrected by the operator unit is gamma corrected by one of a plurality of registers in the gamma control unit.

11. A method for driving an organic electroluminescence display (OELD), comprising:
controlling and correcting color coordinates of a data signal to correspond to an amount of ambient light; and
providing a gamma correction signal of the corrected data signal to a data driver.

12. The method for driving an OELD as claimed in claim 11, further comprising supplying the gamma correction signal to a plurality of data lines in a pixel unit.

13. The method for driving an OELD as claimed in claim 11, further comprises:
converting an analog sensor signal corresponding to a brightness of ambient light into a digital sensor signal;
counting a number of signals during a one frame period so as to generate a counting signal; and
outputting a control signal corresponding to the digital sensor signal and the counting signal.

14. The method for driving an OELD as claimed in claim 11, wherein providing the gamma correction signal includes:
dividing the brightness of the ambient light into a plurality of brightness levels and storing the gamma correction signal so that the plurality of the registers corresponds to the plurality of the brightness levels; and
selecting one of the plurality of registers to correspond to a control signal and output the gamma correction signal stored in the selected register.

15. The method for driving an OELD as claimed in claim 11, wherein the color coordinate includes a luminance value and a saturation value.

16. The method for driving an OELD as claimed in claim 15, wherein the luminance value and the saturation value correspond to a brightness of ambient light.

17. The method for driving an OELD as claimed in claim 11, wherein the data signal is corrected by selecting a gamma correction value according to a brightness of the ambient light.

18. The method for driving an OELD as claimed in claim 11, wherein the data signal is generated by comparing a previously set color coordinate if a brightness of the ambient light is less than a predetermined value.

19. The method for driving an OELD as claimed in claim 11, wherein the data signal is corrected if a brightness of the ambient light is greater than a predetermined value.
